(19) United States
(12) Patent Application Publication
(10) Pub. No.: US 2018/0223479 A1
(43) Pub. Date: Aug. 9, 2018

(54) DUAL FUNCTION REAGENT, TRANSFER FIBERS, TRANSFER LAYER, AND ABSORBENT ARTICLES

(71) Applicant: Rayonier Performance Fibers, LLC, Jacksonville, FL (US)

(72) Inventors: Othman A. HAMED, Savannah, GA (US); Romuald S. KRZYWANSKI, Richmond Hill, GA (US)

(73) Assignee: Rayonier Performance Fibers, LLC, Jacksonville, FL (US)

(21) Appl. No.: 15/426,371

(22) Filed: Feb. 7, 2017

(51) Int. Cl. D21H 17/53; D21H 27/00; C08G 59/14

(52) U.S. Cl. CPC D21H 17/53; C08G 59/1438; D21H 27/002

(57) ABSTRACT

The present invention relates to a dual function reagent composed of a polymeric chain and end caps, transfer fibers made from cellulose fibers and the dual function reagent, a liquid transfer layer made from the transfer fibers, and absorbent articles incorporating the liquid transfer layer. Embodiments of the present invention also relate to methods of making and using the dual function reagent, transfer fibers, transfer layer and absorbent articles.

### FIELD OF THE INVENTION

The present invention relates to a dual function reagent composed of a polymeric chain and end caps, transfer fibers made from cellulose fibers and the dual function reagent, a liquid transfer layer made from the transfer fibers, and absorbent articles incorporating the liquid transfer layer. Embodiments of the present invention also relate to methods of making and using the dual function reagent, transfer fibers, transfer layer and absorbent articles.

### DESCRIPTION OF RELATED ART

Absorbent articles intended for body fluid management typically are comprised of a top sheet, a back sheet, an absorbent core located between the top sheet and back sheet, and an optional transfer layer located between the top sheet and the absorbent core. The transfer layer is mainly comprised of cross-linked cellulosic fibers. A transfer layer composed of cross-linked fibers usually provides better transfer and distribution of liquid, increased rate of liquid absorption, reduced gel blocking, and improved surface dryness.

Transfer layers are usually made from cross-linked cellulose fibers of wood pulp. Cross-linked cellulosic fibers and processes for making them have been known for many years and are described in detail in the literature (see, for example G. C. Tesoro, Cross-Linking of Cellulosics, in Handbook of Fiber Science and Technology, Vol. II, M. Lewis and S. B. Sello eds. pp 1-46, Mercell Decker, New York (1993)). They are typically prepared by reacting cellulose with reagents capable of bridging the hydroxyl groups of the adjacent cellulose chains.

Cross-linked fibers are usually made in two different methods know in the art as dry and wet crosslinking. The characteristics of wet-cross-linked fiber in a dry state are essentially similar to those of untreated fiber. Wet cross-linking of pulp is believed to improve the physical properties of pulp in many ways, such as improving fiber wet resiliency and enhancing moisture regain. The main disadvantages of the wet cross-linked pulp is that it has higher retention under load when compared to dry cross-linked fibers.

Dry cross-linking of fibers usually improve the physical properties of fibers in many ways, such as by improving resiliency (in the dry and wet state), reducing the absorbency under load, and increasing absorbency. For this reason dry cross-linked fiber is preferred over the wet cross-linked fiber for use as a transfer layer in absorbent articles. However, dry cross-linked cellulosic fibers have not been widely adopted in absorbent products, seemingly because of the difficulty of successfully cross-linking cellulosic fibers without causing severe damage to the fiber and discoloration. The damage of the cellulose fiber usually leads to generating successive amount of fines and knots and nits. The discoloration and the amount of knots and nits are even higher when the cellulose fiber is cross-linked in the sheet form.

Methods of making cross-linked fiber are described in several patents like U.S. Pat. Nos. 4,204,054; 3,844,880; 3,700,549; 3,241,553; 3,224,926; 7,074,301; and 7,288,167; European Patent No. 0,427,361 B1; and European Patent No. 1745175A4, the disclosures of which are incorporated by reference herein in their entirety.

Fiber mercerization was another approach for making cross-linked fiber in sheet form. Mercerization is the treatment of fiber with an aqueous solution of sodium hydroxide (caustic). This method was invented 150 years ago by John Mercer (see British Patent 1369, 1850). The process generally is used in the textile industry to improve cotton fabric's tensile strength, dyeability, and luster (see, for example, R Freytag, J.-J. Donze, Chemical Processing of Fibers and Fabrics, Fundamental and Applications, Part A, in Handbook of Fiber Science and Technology, Vol. 1, M. Lewis and S. B. Sello eds. pp. 1-46, Mercell Decker, New York (1983)). The cost for making mercerized cross-lined fiber was high, and for this reason it was never used in absorbent articles.

As shown above there is still a need for reagent and process for making cross-linked pulp at milder temperature and not suffering from the before mentioned disadvantages such as yellowing, cost and high content of knots, nits and fines.

### SUMMARY OF THE INVENTION

In view of the difficulties presented in making cross-linked cellulosic fibers, there is a need for a simple, relatively inexpensive reagent for making cross-linked fibers without sacrificing wettability of the fibers, whereby the resultant cross-linked fibers have low contents of knots and nits, low discoloration, which can be defiberized without a serious fiber breakage, and which can be used as a transfer layer in an absorbent article.

It is therefore a feature of an embodiment of the invention to provide a dual function reagent able to cross-link cellulose chains and to produce a product useful in cellulosic based transfer fibers suitable for use as a transfer layer in an absorbent article intended for body waste management. It also is a feature of an embodiment of the present invention to provide a method of making the cellulosic based transfer fibers in the sheet form using the dual function reagent of the present invention. It is yet another feature of an embodiment of the present invention to provide a method of making the cellulosic based transfer fibers in the slurry form using the dual function reagent of the present invention. It is yet another embodiment of the present invention to make a transfer layer from the cellulosic based transfer fibers of the present invention that improves retention, absorption capacity, absorption rate and absorbency under load of an absorbent article. It is yet another feature of an embodiment of the present invention to provide cellulosic based transfer fibers in sheet form which upon defiberization produces fluff with reduced knots, nits, and fine contents. In yet another feature of an embodiment of the present invention, the transfer fibers may be utilized as a transfer layer or in the absorbent core of an absorbent article.

In accordance with these and other features of embodiments of the invention, there is provided a dual function reagent useful of making cellulosic based transfer fibers. The dual function reagent is composed of two parts: (1) a polymeric chain and (2) end caps. The polymeric chain is a polyalkylene glycol polymer and the end caps are substituents able to react with the hydroxyl groups of the cellulose chain.

In accordance with an additional feature of an embodiment of the present invention, the method is provided of making cellulosic based transfer fibers that includes applying a solution containing a dual function agent of the present invention to cellulosic fibers to impregnate the fibers in sheet form, then drying and curing the impregnated cellulosic fibers. Another suitable method further provides impregnating cellulosic fibers in slurry form with the solution containing the dual function reagent, drying the fibers at a temperature below curing temperature, defiberizing the fibers, and then curing them, or drying and curing in one step.

These and other objects, features and advantages of the present invention will appear more fully from the following detailed description of the preferred embodiments of the invention, and the attached drawings.

### BRIEF DESCRIPTION OF THE FIGURES

FIG. 1 is SEM image at a magnification of 250× of Rayfloc®-J-LD cross-linked in sheet form using the dual function reagent of the present invention.

FIG. 2 is SEM image at a magnification of 500× of Rayfloc®-J-LD cross-linked in slurry form using the dual function reagent of the present invention.

FIG. 3 shows the Single Dose Rewet results of Example 6.

FIG. 4 shows the Overflow test results of Example 7.

FIG. 5 shows the SART test results of Example 8.

### DETAILED DESCRIPTION OF THE INVENTION

The present invention is directed to a dual function reagent composed of a polymeric chain and end caps. The polymeric part is a polyalkylene glycol based polymer and the end caps are substituents composed of polyfunctional organic acids.

The dual function reagents are preferably made by reacting a polyalkylene glycol diglycidyl ether with a polyfunctional organic acid. The dual function reagents are especially useful for making wood pulp with improved bulkiness and low liquid retention under load. The dual function reagent of the present invention is especially useful for use in an absorbent article structure. Embodiments of the present invention may be used with any classes of absorbent structures, without limitation, whether disposable or otherwise.

The present invention concerns cellulosic based transfer fibers that are useful in absorbent articles, and in particular that are useful in forming transfer layers or absorbent cores in the absorbent article. The particular construction of the absorbent article is not critical to the present invention, and any absorbent article can benefit from this invention. Suitable absorbent garments are described, for example, in U.S. Pat. Nos. 5,281,207, and 6,068,620, the disclosures of each of which are incorporated by reference herein in their entirety including their respective drawings. Those skilled in the art will be capable of utilizing the transfer fibers of the present invention in absorbent garments, cores, acquisition layers, and the like, using the guidelines provided herein.

In accordance with embodiments of the present invention, the dual function reagents that are useful in making cellulosic transfer fibers are made by reacting a polyfunctional organic acid and a polyalkylene glycol, preferably a polyalkylene glycol diglycidyl ether. Without being limited to a specific theory, the polyalkylene oxide chain appear to act as “wedges” which disrupt the inter- or intra-fiber hydrogen bonding among fibers and cellulose chains. (See K. D. Sears, et. al., Vol. 27 of JOURNAL OF APPLIED POLYMER SCIENCE, pp. 4599-4610 (1982)). As such, the polyalkylene glycols disrupt the hydrogen bonding sites by occupying the space between the cellulosic chains, thereby by reducing inter-fiber bonding, thus enhancing the fluffing properties of the transfer fiber and reducing knots and knits after defiberization. The functional groups (end caps) serve to bridge the adjacent cellulosic chains through bonding to the hydroxyl groups of the cellulose chains, thereby increasing the resiliency and porosity of the fibers and reducing the hydrophilicity of cellulose.

Any polyfunctional organic acid may be used which is capable of bonding to the polyalkylene glycol and to the hydroxyl groups of the cellulose fibers. Examples of suitable polyfunctional organic acids are polycarboxylic acids, acid aldehydes, phosphonic acids, and combinations thereof.

The term “acid aldehydes” refers to organic molecules having carboxylic acid and aldehyde functional groups, such as glyoxylic acid and succinic semialdehyde.

Examples of preferred polyfunctional organic acids are 1,2,3,4-butanetetracarboxylic acid, 1,2,3-propanetricarboxylic acid, 2,2′-Oxydisuccinic acid; citric acid, glyoxylic acid, iminodiacetic acid, N-(phosphonomethyl)iminodiacetic acid, N,N-Bis(phosphonomethyl)glycine, Nitrilotri(methylphosphonic acid), and mixtures and combinations thereof.

Scheme 1 below shows a reaction scheme for making the dual function reagent of an embodiment of the present invention by reacting a polypropylene glycol diglycidyl ether with citric acid. Scheme 1 shows the structures of three possible major products. Another scheme for making the dual function reagent of the present invention from glyoxylic acid and polypropylene glycol diglycidyl ether is shown in Scheme 2 below.

Preferred polyfunctional organic acids are polycarboxylic acids with C₉ or lower, particularly alkane polycarboxylic acids having one or more hydroxyl groups such as butanetetracarboxylic acid, citric acid, itaconic acid, maleic acid, tartaric acid, and glutaric acid. More preferred is citric acid.

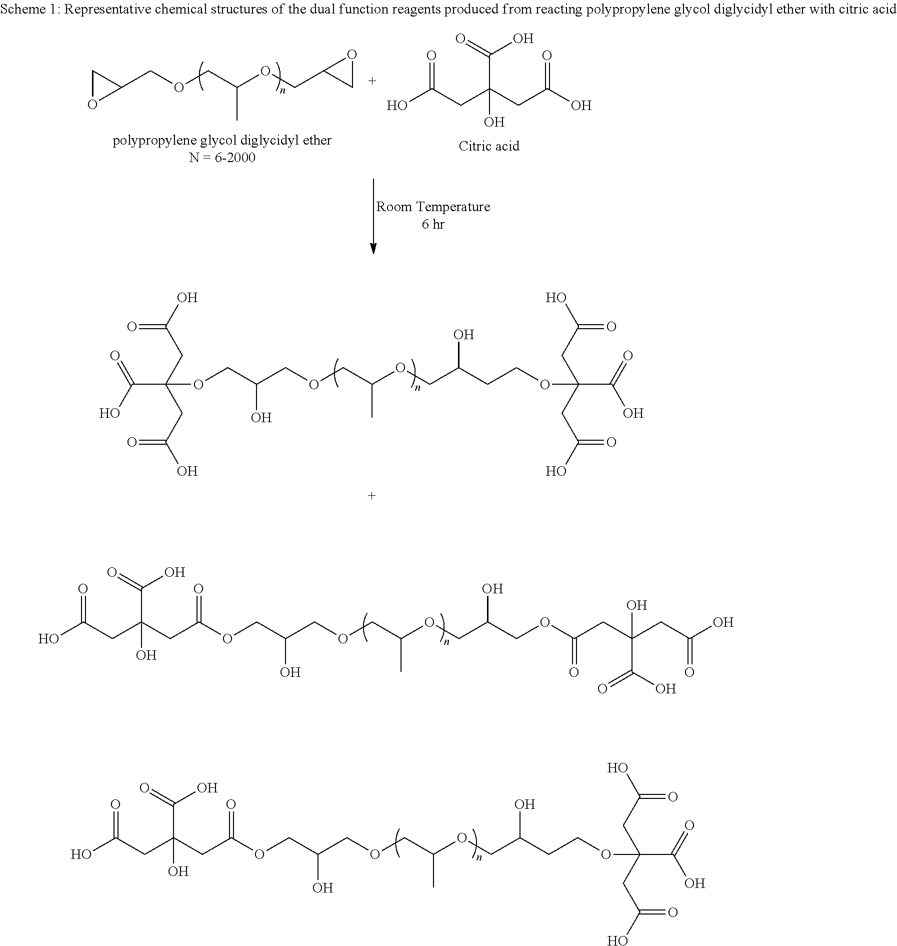

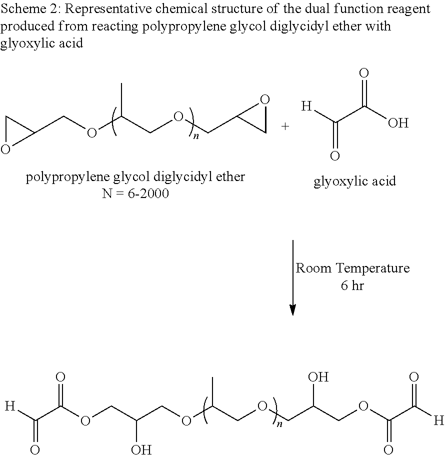

A polyalkylene glycol diglycidyl ether compound that may be used in embodiments of the present invention are polyalkylene oxide diglycidyl ethers that are water soluble or form water soluble products when reacted with polyfunctional organic acids.

The polyalkylene oxide diglycidyl ethers suitable for use in the present invention preferably has the molecular formula R′O—(R—O)nR′ where n could be anywhere from 6 to 2000, R ethyl, isopropyl or butyl and R′ is a glycidyl group.

Typical examples of such polyalkylene glycol diglycidyl ether include but are not limited to: polyethylene glycol diglycidyl ether, polypropylene glycol diglycidyl ether, polytetrahydro furan or any combination thereof.

The dual function reagent may be prepared by any suitable and convenient procedure. The polycarboxylic acid and polyalkylene oxide diglycidyl ether are generally reacted in a mole ratio of polycarboxylic acid to polyalkylene oxide diglycidyl ether of about 10.0:0.1 to about 2.0:1.0. Preferably the reaction is carried out in water at a weight ratio of reactant to solvent from 1:0.1 to 1:20, preferably from 1:0.5 to 1:10. When glyoxylic acid is used, preferably the mole ratio of glyoxylic acid to polyalkylene oxide diglycidyl ether of about 10.0:0.1 to about 1.0:1.0.

The reaction may be carried out within the temperature range of room temperature up to reflux (100° C.). Preferably the reaction is carried out at room temperature for about 4 hours, more preferably for about 12 hours and most preferably for about 24 hours. The product of the reaction is water-soluble, and can be diluted in water to any desirable concentration.

Optionally, a catalyst may be added to the solution to accelerate the reaction between the polycarboxylic acid and the polypropylene glycol diglycidyl ether. Any catalyst known in the art to accelerate the formation of an ether bond or an ester linkage between the two materials could be used in embodiments of the present invention. Preferably, the catalyst is a Lewis acid selected from aluminum sulfate, magnesium sulfate, and any Lewis acid that contains at least a metal and a halogen, including, for example FeCl₃, AlCl₃, TiCl₄ and BF₃.

Another aspect of the present invention provides a method for making cellulosic based transfer fibers using the dual function reagent described above. The process preferably comprises treating cellulose fibers in sheet, roll, fluff or slurry form with an aqueous solution containing the dual function reagents, followed by drying and curing at sufficient temperature and for a sufficient period of time to accelerate the bridging between hydroxyl groups of cellulose fibers and end caps of dual function reagent. Using the guidelines provided herein, those skilled in the art are capable of determining suitable drying and curing temperatures and times.

Cellulosic fibers suitable for use in the present invention include those primarily derived from wood pulp. Suitable wood pulp can be obtained from any of the conventional chemical processes, such as the kraft and sulfite processes. Preferred fibers are those obtained from various softwood pulps such as southern pine, white pine, Caribbean pine, western hemlock, various spruces, (e.g. sitka spruce), Douglas fir or mixtures and combinations thereof. Fibers obtained from hardwood pulp sources, such as gum, maple, oak, eucalyptus, poplar, beech, and aspen, or mixtures and combinations thereof also can be used in the present invention. Other cellulosic fibers derived from cotton linters, bagasse, kemp, flax, and grass also may be used in the present invention. The fibers can be comprised of a mixture of two or more of the foregoing cellulose pulp products. Particularly preferred fibers for use in the making transfer layer of the present invention are those derived from wood pulp prepared by the kraft and sulfite pulping processes.

The cellulosic fibers can be in a variety of forms. For example, one aspect of the present invention contemplates using cellulosic fibers in sheet, roll, or slurry form. In another aspect of the invention, the fibers can be in a mat of non-woven material. Fibers in mat form are typically have a lower basis weight than fibers in the sheet form. In yet another feature of an embodiment of the invention, the fibers can be used in the wet or dry state.

In another embodiment of the invention, fibers in sheet or slurry form suitable for use in the present invention include caustic-treated fibers. A description of the caustic extraction process can be found in Cellulose and Cellulose Derivatives, Vol. V, Partl, Ott, Spurlin, and Grafllin. Eds., Interscience Publisher (1954). Commercially available caustic extractive pulp suitable for use in embodiments of the present invention include, for example, Porosanier-J-HP, available from Rayonier Advanced Materials (Jesup, Ga.), and Georgia Pacific HPZ products.

In one embodiment, the dual function reagent is applied to the cellulose fibers in an aqueous solution. Preferably, the aqueous solution has a pH from about 1 to about 4.5.

Preferably the dual function reagent, after being prepared, is diluted with water to a concentration sufficient to provide from about 1.0 to 10.0 wt. % dual function reagent on fiber, more preferably from about 2 to 8 wt. %, and most preferably from about 2.5 to 5 wt. %. By way of example, 5 wt. % of dual function reagent means 5.0 g of the dual function reagent per 100 g oven dried pulp.

Optionally, the method includes applying a catalyst to accelerate the reaction between hydroxyl groups of cellulose and carboxyl groups of the dual function reagent of the present invention. Suitable catalysts for use in the present invention include alkali metal salts of phosphorous containing acids such as alkali metal hypophosphites, alkali metal phosphites, alkali metal polyphosphonates, alkali metal phosphates, and alkali metal sulfonates. A particularly preferred catalyst is sodium hypophosphite. Preferably the catalyst is applied to fibers as a mixture with the dual function reagent. It could be applied to pulp by other means such as adding it to the fiber before the addition of the dual function reagent, or after the addition of the dual function reagent. A suitable concentration of the catalyst is 0.1 to 1.0 wt % of the total weight of the solution.

Any method of applying the dual function reagent to the fibers may be used. Any method leads to formation of intimate mixture of a dual function reagent and cellulosic fibers could be used, whereby the dual function reagent may be adhered to the fibers, adsorbed on the surface of the fibers, or linked via chemical, hydrogen or other bonding (e.g., Van der Waals forces) to the fibers. Acceptable methods include, for example, suspending, spraying, dipping, impregnation, and the like.

Preferably, fibers in fluff form are suspended in an aqueous solution containing the dual function reagent, then sheeted and pressed to desired solution pick-up. Fiber in sheet form is preferably impregnated with a solution of the dual function reagent, impregnation creates a uniform distribution of the dual function reagent on the sheet and provides better penetration of the dual function reagent into the interior part of the fibers. Fibers in the roll form are conveyed through a treatment zone where the dual function reagent is applied on both surfaces by conventional methods such as spraying, rolling, dipping, knife-coating or any other manner of impregnation. A preferred method of applying the aqueous solution containing the dual function reagent to fibers in the roll form is by puddle press, size press, or blade coater.

Most preferably, an aqueous solution containing the dual function reagent is added to a slurry of fully bleached never dried pulp, then sheeted and pressed to desired solution pick-up.

Fibers in slurry, fluff, roll, or sheet form after treatment with the modifying agent are preferably dried and cured in a two-stage process, and more preferably dried and cured in a one-stage process. Such drying and curing removes water from the fibers, thereupon inducing the formation of σ-bonds between hydroxyl groups of the cellulosic chains and the dual function reagent. Any curing temperature and time can be used so long as they produce the desired effects described herein.

Curing typically is carried out in a forced draft oven preferably from about 60° C. to about 200° C., and more preferably from about 110° C. to about 180° C., and most preferably from about 120° C. to about 170° C. Curing is preferably carried out for a sufficient period of time to permit complete fiber drying and efficient bonding between cellulosic fibers and the dual function reagent. Preferably, the fibers are cured from about 2 min to about 30 min.

In the case where the modification is carried out on pulp in fluff form, preferably the pulp is slurred in a solution of the dual function reagent, sheeted, pressed to a desired pick-up and dried at a temperature below curing temperature, and then heated at elevated temperatures to promote bonding formation between fibers and the modifying agent, or dried and cured at an elevated temperature in a one step process.

In an alternate embodiment of the present invention, the pulp in slurry form are treated initially with the modifying agent, dried at a temperature below curing, defiberized, and then cured at elevated temperature.

In another alternate embodiment of the present invention, the pulp is treated initially with the dual function reagent while in the sheet form, dried at a temperature below curing temperature, defiberized by passing them through a hammermill or the like, and then heated at elevated temperatures to promote bonding formation between cellulose chains and the modifying agent.

The morphologies of cellulosic based transfer fibers of the present invention, prepared in slurry form and sheet form from conventional fibers (Rayfloc®-J-LD) were examined with Scanning Electron Microscopy (SEM) (S360 Leica Cambridge Ltd., Cambridge, England) at 15 kV. The samples were coated with gold using a sputter coater (Desk-II, Denton Vacuum Inc.) for 90 seconds with a gas pressure of lower than about 50 mtorr and a current of about 30 mA.

The SEM image illustrated in FIG. 1 represents cellulosic based transfer fibers prepared in sheet form. As shown in FIG. 1 the fibers have an almost flat ribbon with some twists and curls.

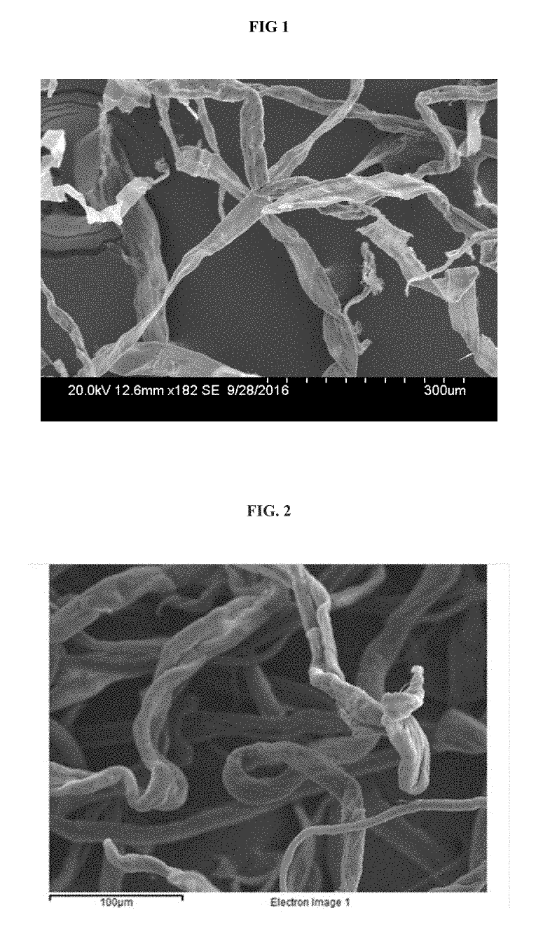

The SEM photograph illustrated in FIG. 2 represents fibers cross-linked in fluff form. The fibers have a flat ribbon like shape with twists and curls.

The cellulosic based transfer fibers made in accordance with embodiments of the present invention preferably possess characteristics that are desirable as a transfer layer in absorbent articles. For example, the fibers preferably have a liquid retention after centrifuge (RAC) not higher than 0.65 grams of synthetic saline per gram of fiber at a centrifuge speed of 1300 rpm (hereinafter “g/g”).

The retention after centrifuge measures the ability of the fibers to retain fluid against a centrifugal force. The cellulosic based transfer fibers preferably has a free swell (FS) of greater than about 9.0 g/g, and absorbency under load of 0.3 psi of greater than about 8.0 g/g.

The free swell measures the ability of the fibers to absorb fluid without being subjected to a confining or restraining pressure over a time period of 10 min. The absorbency under load measures the ability of the fibers to absorb fluid against a restraining or confining force of 0.3 psi over a time period of 10 min. The liquid retention under centrifuge, free swell, and absorbency under load preferably are determined by the hanging cell method described in the example section.

There are other advantages for the transfer fibers of the present invention. Preferably transfer fibers made in accordance with the present invention contain less than 25.0% knots and fines.

The properties of the cellulosic based transfer fibers prepared in accordance with the present invention make the fibers suitable for use, for example, as a bulking material, in the manufacturing of high bulk specialty fibers that require good absorbency and porosity. The transfer fibers can be used, for example, in absorbent products. The fibers may also be used alone, or preferably incorporated into other cellulosic fibers to form blends using conventional techniques, such as air laying techniques. In an airlaid process, the cellulosic based transfer fibers of the present invention alone or in combination with other fibers are blown onto a forming screen or drawn onto the screen via a vacuum. Wet laid processes may also be used, combining the cellulosic based transfer fibers of the invention with other cellulosic fibers to form sheets or webs of blends.

The cellulosic based transfer fibers of the present invention may be incorporated into various absorbent articles, preferably intended for body waste management such as adult incontinent pads, feminine care products, and infant diapers. The cellulosic based transfer fibers can be used as a transfer layer in the absorbent articles, wherein it placed as a separate layer on top of the absorbent core, and it can be utilized in the absorbent core of the absorbent articles. Towels and wipes also may be made with the cellulosic fibers of the present invention, and other absorbent products such as filters.

The transfer fibers of the present invention were incorporated into an absorbent article as a transfer layer, and evaluated by the several tests shown in the examples section such as a Single Dose Rewet, Overflow test and Specific Absorption Rate Test (SART). The tests results show that the absorbent article that contained cellulosic based transfer fibers of the present invention provided results comparable to those obtained by using commercial cross-linked fibers, especially those cross-linked with polycarboxylic acids.

In order that various embodiments of the present invention may be more fully understood, the invention will be illustrated, but not limited, by the following examples. No specific details contained therein should be understood as a limitation to the present invention except insofar as may appear in the appended claims.

### EXAMPLES

The following test methods were used to measure and determine various physical characteristics of the inventive cellulosic based transfer fibers.

### Hanging Cell Test Method

The absorbency test method was used to determine the absorbency under load, free swell, and retention after centrifuge. The test was carried out in a one inch inside diameter plastic cylinder having a 100-mesh metal screen adhering to the cylinder bottom “cell,” containing a plastic spacer disk having a 0.995 inch diameter and a weight of about 4.4 g. In this test, the weight of the cell containing the spacer disk was determined to the nearest 0.001 g, and then the spacer was removed from the cylinder and about 0.35 g (dry weight basis) of cellulosic based acquisition fibers were air-laid into the cylinder. The spacer disk then was inserted back into the cylinder on the fibers, and the cylinder group was weighed to the nearest 0.001 g. The fibers in the cell were compressed with a load of 4.0 psi for 60 seconds, the load then was removed and fiber pad was allowed to equilibrate for 60 seconds. The pad thickness was measured, and the result was used to calculate the dry bulk of cellulosic based acquisition fibers.

A load of 0.3 psi was then applied to the fiber pad by placing a 100 g weight on the top of the spacer disk, and the pad was allowed to equilibrate for 60 seconds, after which the pad thickness was measured, and the result was used to calculate the dry bulk under load of the cellulosic based acquisition fibers. The cell and its contents then were hanged in a Petri dish containing a sufficient amount of saline solution (0.9% by weight saline) to touch the bottom of the cell. The cell was allowed to stand in the Petri dish for 10 minutes, and then it was removed and hanged in another empty Petri dish and allowed to drip for about 30 seconds. The 100 g weight then was removed and the weight of the cell and contents was determined. The weight of the saline solution absorbed per gram fibers then was determined and expressed as the absorbency under load (g/g). The free swell of the cellulosic based transfer fibers was determined in the same manner as the test used to determine absorbency under load above, except that this experiment was carried using a load of 0.01 psi. The results are used to determine the weight of the saline solution absorbed per gram fiber and expressed as the absorbent capacity (g/g).

The cell then was centrifuged for 3 min at 1400 rpm (Centrifuge Model HN, International Equipment Co., Needham HTS, USA), and weighed. The results obtained were used to calculate the weight of saline solution retained per gram fiber, and expressed as the retention after centrifuge (g/g).

### Fiber Quality

Fiber quality evaluations (fiber length, kink, curl, and fines content) were carried out on an OpTest Fiber Quality Analyzer (OpTest Equipment Inc., Waterloo, Ontario, Canada) and Fluff Fiberization Measuring Instruments (Model 9010, Johnson Manufacturing, Inc., Appleton, Wis., USA). Pampers®.

Fluff Fiberization Measuring Instrument is used to measure knots, nits and fines contents of fibers. In this instrument, a sample of fibers in slurry form was continuously dispersed in an air stream. During dispersion, loose fibers passed through a 16 mesh screen (1.18 mm) and then through a 42 mesh (0.36 mm) screen. Pulp bundles (knots) which remained in the dispersion chamber and those that were trapped on the 42-mesh screen were removed and weighed. The formers are called “knots” and the latter “accepts.” The combined weight of these two was subtracted from the original weight to determine the weight of fibers that passed through the 0.36 mm screen. These fibers were referred to as “fines.”

Examples 1 to 3 illustrates a representative method for making a solution of dual function reagent of an embodiment of the present invention and use it in making transfer fibers in sheet form using the impregnation technique.

### Example 1

To a citric acid (20.0 g, 0.104 mol) solution in water (20 mL) was added polyethylene glycol diglycidyl ether (10.0 g, 0.02 mol). The produced solution was stirred at room temperature until a clear viscous solution was obtained (12 hr). The solution was stirred for another 6 hours, then it was diluted with distilled water to about 800 mL. The pH was then adjusted to about 3.0 with an aqueous solution of NaOH (10 wt %). After stirring for a few minutes sodium hypophosphite (3.0 g, 0.3% by wt. of solution) was added. The stirring was continued for few more minutes, then more water was added to adjust the total weight of the solution to 1.0 kg (final concentration of dual function reagent is 3.0%).

The produced solution was added to a plastic tray, a sheet of Rayfloc-J-LDE (12× 12 inch², basis weight 680 gsm) was dipped in the solution then pressed to achieve the desired level of dual function reagent on pulp (about 3.0 wt. %). Several sheets were prepared in the same manner, dried at 80° C., and then cured at various temperatures for a fixed period of time as shown in Table I. The curing of all samples was carried out in an air driven laboratory oven. Prepared sheets of transfer fibers were defiberized by feeding it through a hammermill and evaluated by hanging cell test and fiber quality test. Test results are summarized in Tables I and II.

TABLE I

Hanging Cell test results (g/g)

| | Curing | | | Retention |
|---|---|---|---|---|
| Sample | Temperature | Free | Absorbency | After |
| No. | (° C.) | Swell | under Load | Centrifuge |
| 1 | 120 | 10.1 | 9.1 | 0.65 |
| 2 | 140 | 11.3 | 9.3 | 0.55 |
| 3 | 160 | 11.5 | 9.5 | 0.52 |

TABLE II

| | | |
|---|---|---|
| Sample | Kamas Energy | Johnson Classification (%) |

| No | (Watts/Kg) | Accepts | Knots | Fines |
|---|---|---|---|---|
| 1 | 33.2 | 88.8 | 12.1 | 4.3 |
| 2 | 34.2 | 80.8 | 15.6 | 3.6 |
| 3 | 41.0 | 72.3 | 22.9 | 4.7 |

### Example 2

To an aqueous solution (50%) of citric acid (20.0 g, 0.104 mol) was added polypropylene glycol diglycidyl ether (12.8 g, 0.02 mol). The produced suspension was stirred at room temperature until a clear viscous solution was obtained (12 hr). The solution was stirred for another 6 hours, then it was diluted with distilled water to about 800 mL. The pH was then adjusted to about 3.0 with an aqueous solution of NaOH (10 wt %). After stirring for a few minutes sodium hypophosphite 3.0 g (0.3% by wt. of solution) was added. The stirring was continued for few more minutes, then more water was added to adjust the total weight of the solution to 1.0 kg (final concentration of dual function reagent is 4.0%).

The produced solution was added to a plastic tray, a sheet of Rayfloc-J-LDE (12×12 inch², basis weight 680 gsm) was dipped in the solution then pressed to achieve the desired level of dual function reagent on pulp (about 4.0 wt. %). Several sheets were prepared in the same manner, dried at 105° C., and then cured at various temperatures for a fixed period of time as shown in Table III. Prepared sheets of transfer fibers were defiberized by feeding it through a hammermill and evaluated by hanging cell test and fiber quality test. Test results are summarized in Tables III and IV.

TABLE III

Hanging Cell test results (g/g)

| | Curing | | | Retention |
|---|---|---|---|---|
| Sample | Temperature | Free | Absorbency | After |
| No. | (° C.) | Swell | under Load | Centrifuge |
| 4 | 120 | 10.3 | 9.3 | 0.68 |
| 5 | 140 | 10.7 | 9.5 | 0.55 |
| 6 | 160 | 11.3 | 96 | 0.49 |

TABLE IV

| | | |
|---|---|---|
| Sample | Kamas Energy | Johnson Classification (%) |

| No | (Watts/Kg) | Accepts | Knots | Fines |
|---|---|---|---|---|
| 4 | 30.0 | 87.8 | 9.9 | 3.4 |
| 5 | 28.8 | 83.0 | 13.4 | 3.4 |
| 6 | 30.1 | 77.1 | 18.4 | 4.4 |

### Example 3

To an aqueous solution (50%) of citric acid (30.0 g, 0.153 mol) was added polypropylene glycol diglycidyl ether (12.8 g, 0.02 mol). The produced suspension was stirred at room temperature until a clear viscous solution was obtained (12 hr). The solution was stirred for another 6 hours, then it was diluted with distilled water to about 800 mL. The pH was then adjusted to about 3.0 with an aqueous solution of NaOH (10 wt %). After stirring for a few minutes sodium hypophosphite 3.0 g (0.3% by wt. of solution) was added. The stirring was continued for few more minutes, then more water was added to adjust the total weight of the solution to 1.0 kg (final concentration of dual function reagent is 4.0%).

The produced solution was added to a plastic container, a sample dry Rayfloc-J-LDE in a fluff form was suspended in the solution at 4% consistency, mixed for 5 min, sheeted (12×12 inch², basis weight 680 gsm) and pressed to a 100% liquid pick up (3% dual function reagent on pulp). Several samples were prepared in the same manner, dried and cured in a one step process at various temperatures for fixed period of time as shown in Table V. Prepared sheets of transfer fibers were defiberized by feeding it through a hammermill and evaluated by hanging cell test and fiber quality test. Test results are summarized in Tables V and VI.

TABLE V

Hanging Cell test results (g/g)

| | Curing | | | Retention |
|---|---|---|---|---|
| Sample | Temperature | Free | Absorbency | After |
| No. | (° C.) | Swell | under Load | Centrifuge |
| 7 | 120 | 10.0 | 9.0 | 0.58 |
| 8 | 140 | 10.8 | 9.7 | 0.53 |
| 9 | 160 | 12.0 | 9.0 | 0.45 |

TABLE VI

| | | |
|---|---|---|
| Sample | Kamas Energy | Johnson Classification (%) |

| No | (Watts/Kg) | Accepts | Knots | Fines |
|---|---|---|---|---|
| 7 | 26.0 | 89.0 | 6.0 | 4.0 |
| 8 | 27.0 | 87.0 | 7.0 | 5.0 |
| 9 | 29.0 | 77.0 | 15.0 | 7.0 |

### Example 4

In this example, the preparation of the dual function reagent was performed in the same manner as in Example 2.

The produced solution was added to a plastic container, a sample Rayfloc-J-LDE in a slurry form was suspended in the solution at 4% consistency, mixed for 5 min, sheeted (12×12 inch², basis weight 680 gsm) and pressed to a 100% liquid pick up (3% dual function reagent on pulp). Several samples were prepared in the same manner, dried and cured in a one step process at various temperatures for fixed period of time as shown in Table VII. Prepared were evaluated by hanging cell test and fiber quality test. Test results are summarized in Tables VII and VIII.

TABLE VII

Hanging Cell test results (g/g)

| | Curing | | | Retention |
|---|---|---|---|---|
| Sample | temperature | Free | Absorbency | After |
| No. | (° C.) | Swell | under Load | Centrifuge |
| 10 | 120 | 10.2 | 9.2 | 0.65 |
| 11 | 140 | 11.5 | 9.6 | 0.61 |
| 12 | 150 | 11.2 | 10.0 | 0.55 |
| 13 | 160 | 11.6 | 10.5 | 0.52 |

TABLE VIII

| Sample | Johnson Classification (%) | | |
|---|---|---|---|
| No | Accepts | Knots | Fines |
| 10 | 82.0 | 12.0 | 4.0 |
| 11 | 84.0 | 10.0 | 5.0 |
| 12 | 80.0 | 14.0 | 4.0 |
| 13 | 79.0 | 17.0 | 5.0 |

### Example 5

To an aqueous solution of glyoxylic acid (50%, 40.0 g, glyoxylic acid: 20.0 g, 0.27 mol) was added polypropylene glycol diglycidyl ether (12.8 g, 0.02 mol). The produced mixture was stirred at room temperature until viscose clear solution was obtained (about 12 hr). The solution was stirred for another 6 hours, then it was diluted with distilled water o 1000 mL, the final concentration of dual function reagent is 3.0%.

The produced solution was added to a plastic try, a sheet of Rayfloc-J-LDE (12× 12 inch², basis weight 680 gsm) was dipped in the solution then pressed to achieve the desired level of dual function reagent on pulp (about 4.0 wt. %). Several sheets were prepared in the same manner, dried at 60° C. and then cured at various temperatures for a fixed period of time as shown in Table IX. Prepared sheets of transfer fibers were defiberized by feeding it through a hammermill and evaluated by hanging cell test and Fiber quality test. Test results are summarized in Tables IX and X.

TABLE IX

Hanging Cell test results (g/g)

| | Curing | | | Retention |
|---|---|---|---|---|
| Sample | temperature | Free | Absorbency | After |
| No. | (° C.) | Swell | under Load | Centrifuge |
| 14 | 120 | 10.0 | 9.0 | 0.57 |
| 15 | 140 | 10.6 | 9.7 | 0.50 |
| 16 | 150 | 10.7 | 9.4 | 0.49 |

TABLE X

| | | |
|---|---|---|
| Sample | Kamas Energy | Johnson Classification (%) |

| No | (Watts/Kg) | Accepts | Knots | Fines |
|---|---|---|---|---|
| 14 | 26.0 | 82.0 | 13.0 | 4.5 |
| 15 | 28.0 | 78.0 | 15.4 | 6.0 |
| 16 | 19.0 | 74.0 | 19.0 | 7.0 |

### Example 6

### Single Dose Rewet

The cellulosic based acquisition fibers made in accordance with the present invention were evaluated for a single dose rewet. The test measures the rate of absorption of a single fluid insults to an absorbent product and the amount of fluid which can be detected on the surface of the absorbent structure after its saturation with a given amount of saline while the structure under a load of 3 kpa. This method is suitable for absorbent material especially those intended for urine application.

The absorbent core and the transfer layer are prepared at the lab to minimize the variation with the following specifications:

A 50 cm² transfer layer with a 200 g/m², a 0.06 g/cm³ density was placed on the absorbent core and covered with a coverstock and barrier film. The absorbent core has a 600 g/m² pulp and 40% super absorbent polymer (SAP) with a 0.15 g/cm³ density.

The absorbent structure was dosed with 30 ml of saline solution, allowed to stand for 120 seconds. A previously weighed a stack of filter paper (15 of Whatman #4 (70 mm)) is placed over the solution insult point on the test sample, and a 3 kpa weight is then placed on the stack of the filter papers on the test sample and allowed to stand for an additional 120 seconds. The difference between the initial dry weight of the filter papers and final wet filter weight is recorded as the “rewet value” of the test specimen. The test was run in triplicate on all tested samples.

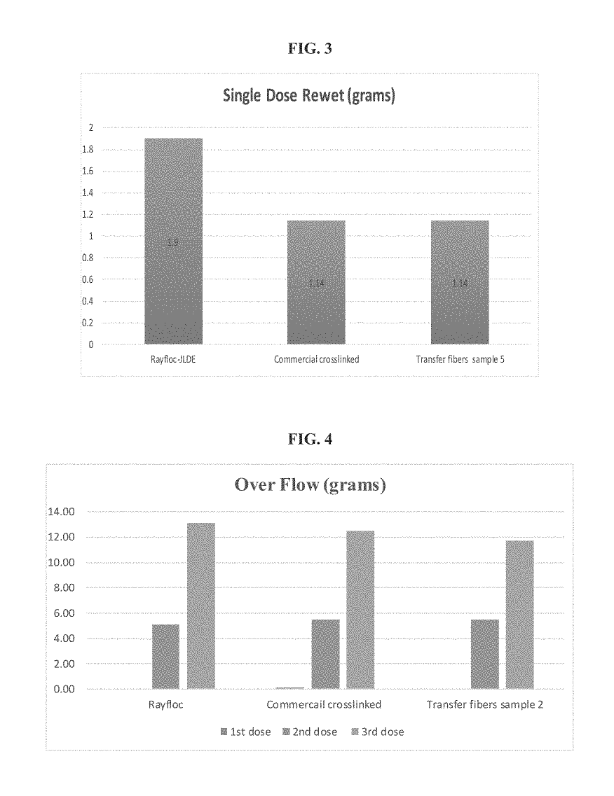

Three samples were evaluated for comparison purpose: transfer fibers (sample 2 table 1), Rayfloc-J-LDE, and commercial cross linked. The results are summarized in FIG. 3.

### Example 7

### Overflow Test

Dosage=3 dose 30 ml each @ 7 ml/sec.

100 gram large orifice tester

The absorbent core and the transfer layer are prepared in the lab to minimize the variation with the following specifications:

An air laid transfer layer with a 50 cm² area, 200 g/m² and 0.06 g/cm³ density was placed on the absorbent core and covered with a coverstock and barrier film. The absorbent core has a 600 g/m² pulp and 40% super absorbent polymer (SAP) with a 0.15 g/cm³ density

The structure was dosed with saline 3×30 mL using a fluid delivery column at a 1 inch diameter impact zone under a 0.1 psi load. After each the structure was allowed to equilibrate for 120 seconds then a previously weighed a stack of filter paper (e.g., 15 of Whatman #4 (70 mm)) is placed over the solution the insult point on the test sample, and a weight of 3 Kpa is then placed on the stack of the filter papers on the test sample for 2 minutes. The wet filter papers are then removed, and the wet weight is recorded. The difference between the initial dry weight of the filter papers and final wet filter weight is recorded as the “rewet value”.

Three samples were evaluated for comparison purpose: transfer fibers (sample 2 table 1), Rayfloc-J-LDE, and commercial cross-linked. The results are summarized in FIG. 4.

### Example 8

### Fiber Specific Absorption Rate Test (SART)

The cellulosic based acquisition fibers made in accordance with an embodiment of the present invention were tested for liquid acquisition properties. To evaluate the acquisition properties, the acquisition time, the time required for a dose of saline to be absorbed completely into the absorbent article was determined.

The Acquisition Time was determined by the SART test method. The test was conducted on an absorbent core obtained from a commercially available diaper stage 4 Pampers®. A sample core was cut from the center of the diaper, had a circular shape with a diameter of about 60.0 mm, and weighed about 1.5 g (±0.2 g).

In this test, the acquisition layer of the sample core was replaced with an airlaid pad made from the cellulosic based acquisition fibers of an embodiment of the present invention. The fiber pad weighed about 0.7 g and was compacted to a thickness of about 3.0 to about 3.4 mm before it was used.

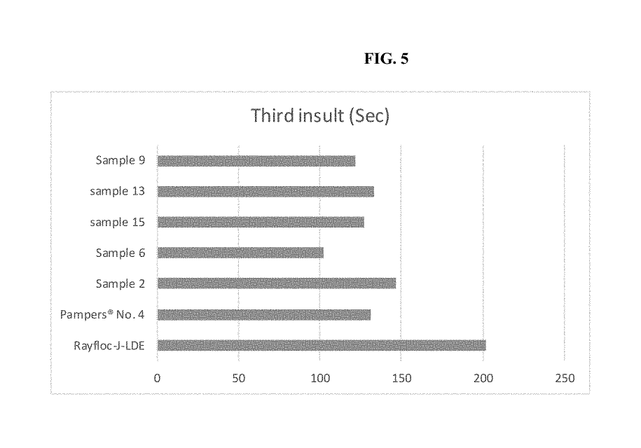

The core sample including the acquisition layer was placed into the testing acquisition apparatus. The acquisition apparatus with a load of 0.7 psi and its contents were placed on a leveled surface and dosed with three successive insults, each being 9.0 ml of saline solution, (0.9% by weight), the time interval between doses being 20 min. The time in seconds required for the saline solution of each dose to disappear from the funnel cup was recorded and expressed as an acquisition time, or strikethrough. The third insult strikethrough time is provided in FIG. 5. The data in FIG. 5 includes the results obtained from testing acquisition layers of commercial cross-linked fibers and conventional uncross-linked fibers. It can be seen from FIG. 5 that the acquisition times of the modified fibers of embodiments of the present invention are as good as or better than the acquisition time for the commercial cross-linked fibers.

1. A dual function reagent comprising a polymeric chain having end caps, wherein the polymeric chain is a polyalkylene glycol polymer and the end caps are a polyfunctional organic acid.

2. The dual function reagent of claim 1, wherein the dual function reagent is the reaction product of a polyfunctional organic acid and a polyalkylene glycol diglycidyl ether.

3. The dual function reagent of claim 1, wherein the polyfunctional organic acid is selected from the group consisting of: 1,2,3,4-butanetetracarboxylic acid, 1,2,3-propanetricarboxylic acid, 2,2′-Oxydisuccinic acid; citric acid, glyoxylic acid, iminodiacetic acid, N-(phosphonomethyl)iminodiacetic acid, N,N-Bis(phosphonomethyl)glycine, Nitrilotri(methylphosphonic acid) and mixtures and combinations thereof.

4. The dual function reagent of claim 1, wherein the polyfunctional organic acid is citric, N-(phosphonomethyl)iminodiacetic acid or glyoxylic acid.

5. The dual function reagent of claim 1, wherein the polyalkylene glycol diglycidyl ether is water soluble or form water soluble dual function reagent.

6. The dual function reagent of claim 2, wherein the polyalkylene glycol diglycidyl ether is polyethylene glycol diglycidyl ether and polypropylene glycol diglycidyl ether.

7. Transfer fibers comprising cellulose fibers which are crosslinked with the dual function reagent of claim 1, wherein the transfer fibers have after centrifuge retention at 1300 rpm of less than 0.65 grams of a 0.9% by weight saline solution per gram, absorbent capacity of not lower than 8.0 g saline/gram, and a free swell higher than 9.0 g saline/gram.

8. The transfer fibers of claim 7, whereby the transfer fibers after defiberization have a knots and fines contents of less than 25%.

9. A transfer layer comprising the transfer fibers of claim 7 in a sheet form.

10. An absorbent article comprising the transfer layer according to claim 9 and an absorbent.

11. A process for making the dual function reagent of claim 1, the process comprising reacting a polyfunctional organic acid and polyalkylene glycol diglycidyl ether compound in water.

12. The process of claim 11, wherein the polyfunctional organic acid and polyalkylene glycol diglycidyl ether are mixed in a weight ratio of from about 1:0.1 to about 2:1.

13. The process of claim 11, wherein the reaction between polyfunctional organic acid and polyalkylene glycol diglycidyl ether is carried out at room temperature to water reflux temperature for at least 4 hr.

14. A method of making cellulosic transfer fibers comprising: providing a solution comprising a dual function reagent of claim 1; providing cellulosic base fiber; applying the solution of the dual function reagent to cellulosic fibers to impregnate the cellulosic based fibers; and drying and curing the treated cellulosic fibers.

15. The method of claim 14, wherein the solution of the dual function reagent has a pH of about 1.5 to about 4.

16. The method of claim 14, wherein applying the solution of the modifying agent to the cellulosic based fiber include any method produced impregnated the cellulose fiber such as: suspending, spraying, dipping or applying with a puddle press, size press or a blade-coater.

17. The method of claim 14, wherein the cellulosic fiber is provided in sheet or slurry form.

18. The method of claim 14, wherein the cellulosic fiber is provided in nonwoven mat form.

19. The method of claim 14, wherein the solution of the dual function reagent is applied to the cellulosic fibers to provide 1 wt % to about 6 wt % of dual function reagent on cellulosic fiber.

20. The method of claim 14, wherein the solution of the dual function reagent comprises a catalyst to accelerate the bridging between the hydroxyl groups of the cellulosic based fiber and the end caps of the dual function reagent.

21. The method of claim 20, wherein the catalyst is selected from alkali metal hypophosphites, alkali metal phosphites, alkali metal polyphosphonates, alkali metal phosphates, and alkali metal sulfonates.

22. The method of claim 20, wherein the catalyst is added in an amount of from about 0.01 to 0.5 weight %, based on the total weight of the solution of the dual function reagent.

23. The method of claim 14, wherein the cellulosic fiber is provided in a dry state or a never dried state.

24. The method of claim 14, wherein the cellulosic fiber is a conventional cellulose fiber selected from the group consisting of: hardwood cellulose pulp, softwood cellulose pulp obtained from a Kraft or sulfite chemical process, and combinations and mixtures thereof.

25. The method of claim 14, wherein the cellulosic fiber is mercerized or partially mercerized pulp.

26. The method of claim 14, wherein the cellulosic fiber is selected from the group consisting of non-bleached, partially bleached and fully bleached cellulosic fibers.

27. The method of claim 14, wherein the drying and curing occurs in a one-step process.

28. The method of claim 14, wherein the drying and curing is conducted at a temperature within the range of about 60° C. to about 180° C. for a period of time ranging from 2 min to 30 min.

29. The method of claim 14, wherein the drying and curing occurs in a two-step process.

30. The method of claim 14, wherein the drying at a temperature within the range of about 60° C. to about 140° C. and the curing at a temperature within the range of about 120° C. to about 180° C.
